(19) United States
(12) Patent Application Publication
(10) Pub. No.: US 2008/0248455 A1
(43) Pub. Date: Oct. 9, 2008

(54) APPARATUS, SYSTEM, AND METHOD FOR REMOTELY CONTROLLING A MULTISCREEN DISPLAY FOR DELIVERY OF INSTRUCTIONAL INFORMATION

(76) Inventor: Bernhard Dohrmann, Madison, AL (US)

Correspondence Address: Kunzler & McKenzie, 8 EAST BROADWAY, SUITE 600, SALT LAKE CITY, UT, 84111, US

(21) Appl. No.: 11/866,935

(22) Filed: Oct. 3, 2007

Related U.S. Application Data
(60) Provisional application No. 60/828,173, filed on Oct. 4, 2006.

(51) Int. Cl. G09B 19/00

(52) U.S. Cl. 434/365

(57) ABSTRACT

An apparatus, system, and method are disclosed for remotely controlling multiple displays for delivery of instructional information from multiple inputs. A setup module is included to store a plurality of display instructions where each display instruction is configured to display at least one image of one or more input devices on each of at least three display devices and each display device capable of displaying a separate image to students in a classroom. A linking module is included to link one or more display instructions with a preset. The preset is located on a remote control device with a plurality of presets. A display module is included to display the images from the input devices on the display devices associated with a display instruction in response to a user selecting the preset linked to the one or more display instructions.

### CROSS-REFERENCES TO RELATED APPLICATIONS

This application claims priority to U.S. Provisional Patent Application No. 60/828,173 entitled “Apparatus, System, and Method for Remotely Controlling a Multiscreen Display for Delivery of Instructional Information” and filed on Oct. 4, 2006 for Bernhard Dohrmann, which is incorporated herein by reference.

### BACKGROUND OF THE INVENTION

1. Field of the Invention

This invention relates to control of a display and more particularly relates to controlling a multi-screen display.

2. Description of the Related Art

Traditional class instruction focuses on an instructor lecturing at the front of a classroom while students take notes. However, traditional instruction often leads to the student's minds wandering. Students are easily distracted and often do not stay focused on the lecturer. Currently, most instructors use technology in a limited way. Sometimes instructors use overhead projectors or slide presentations instead of a traditional chalkboard. More technology savvy instructors may use PowerPoint® presentations or other computer-generated images. Remote learning facilities may also use cameras to display an image of the instructor or display a document. The current marginal use of technology may help to maintain the attention of the students, but currently not enough is being done to sharpen the focus of students on the material being presented.

Where instructors use computer displays, televisions, etc., they are often tied to a teaching station hard-wired to controls for the display devices. The instructors are tied to the location of the teaching station or display device which may hinder teaching performance. Where remote devices are used, such as a television remote, the remote is generally limited to controlling the device to which the remote is dedicated. The limited use of technology by most instructors and the lack of mobility of the instructors limits the instructors' ability to keep the students focused on the material being presented.

### SUMMARY OF THE INVENTION

From the foregoing discussion, it should be apparent that a need exists for an apparatus, system, and method that provide a more flexible way to control multiple three or more display devices using a remote control device. Beneficially, such an apparatus, system, and method would enhance the teaching experience by providing a way to maintain the students' focus on the material being presented while allowing the instructor to move about the classroom freely.

The present invention has been developed in response to the present state of the art, and in particular, in response to the problems and needs in the art that have not yet been fully solved by currently available instruction methods. Accordingly, the present invention has been developed to provide an apparatus, system, and method for remotely controlling multiple displays for delivery of instructional information from multiple inputs that overcome many or all of the above-discussed shortcomings in the art.

The apparatus to remotely control multiple displays for delivery of instructional information from multiple inputs is provided with a plurality of modules configured to functionally execute the necessary steps of storing display instructions, linking the display instructions to presets on a remote control device, and displaying images from the input devices once a preset is selected. These modules in the described embodiments include a setup module that stores a plurality of display instructions. Each display instruction is configured to display at least one image of one or more input devices on each of at least three display devices. Each display device is capable of displaying a separate image to students in a classroom.

The apparatus includes a linking module that links one or more display instructions with a preset. The preset located on a remote control device and the remote control device includes a plurality of presets. The apparatus includes a display module that displays the images from the input devices on the display devices associated with a display instruction in response to a user selecting the preset linked to the one or more display instructions.

In one embodiment, the apparatus includes an override module that displays at least one override function of the remote control device such that selecting the at least one override function overrides at least a portion of a display instruction being executed. In another embodiment, the display module displays instructional information one at least one display device and background information on the display devices not displaying instructional information. In another embodiment, the background information includes images displayed in a random sequence.

A system of the present invention is also presented to remotely control multiple displays for delivery of instructional information from multiple inputs. The system may be embodied by at least three display devices each capable of displaying a separate image to students in a classroom, at least one input device configured to output at least one image, a remote control device comprising a plurality of presets, and a microprocessor in communication with the at least three display devices, the at least one input device, and the remote control device. In particular, the microprocessor includes, in one embodiment, a setup module that stores a plurality of display instructions and each display instruction is configured to display at least one image of an input device on each display device. The microprocessor includes a linking module that links one or more display instructions with a preset where the preset is located on the remote control device. The microprocessor includes a display module that displays the images from the input devices on the display devices associated with a display instruction in response to a user selecting the preset linked to the one or more display instructions.

In one embodiment, the remote control device includes a touch screen and the presets include icons on the touch screen. In another embodiment, the system includes a router that connects the input devices to the display devices in response to a display instruction received by the router from the computer. In another embodiment, the system includes an audio system that receives sound of an input device through the router. The audio system includes an amplifier and at least one speaker.

In one embodiment, the one or more display instructions include an instruction for each display device and each of the instructions comprises connecting one input device to one display device. In another embodiment, the at least one input device is one of a camera, a digital video disk (“DVD”) player, a video cassette recorder (“VCR”), an Internet web page, a compact disk (“CD”) player, a scanner, a digital audio tape player, a flash memory drive, an optical drive, a hard disk drive, and the computer.

In one embodiment, the system includes an override module that displays at least one override function of the remote control device such that selecting the at least one override function overrides at least a portion of a display instruction being executed. In another embodiment, the at least three display devices include three projectors that display images on three projection screens. In another embodiment, the projection screens are configured in a “V” configuration. In yet another embodiment, at least one preset displays a mix of background images and lesson text.

A method of the present invention is also presented for remotely controlling multiple displays for delivery of instructional information from multiple inputs. The method in the disclosed embodiments substantially includes the steps necessary to carry out the functions presented above with respect to the operation of the described apparatus and system. In one embodiment, the method includes storing a plurality of display instructions where each display instruction is configured to display at least one image of one or more input devices on each of at least three display devices and each display device is capable of displaying a separate image to students in a classroom. The method also includes linking one or more display instructions with a preset where the preset is located on a remote control device and the remote control device includes a plurality of presets. The method includes displaying the images from the input devices on the display devices associated with a display instruction in response to a user selecting the preset linked to the one or more display instructions.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system to remotely control multiple displays for delivery of instructional information from multiple inputs in accordance with the present invention;

FIG. 2 is a schematic block diagram illustrating one embodiment of an apparatus to remotely control multiple displays for delivery of instructional information from multiple inputs in accordance with the present invention;

FIG. 3 is a schematic flow chart diagram illustrating one embodiment of a method for remotely controlling multiple displays for delivery of instructional information from multiple inputs in accordance with the present invention; and

FIG. 4 is a schematic block diagram illustrating one embodiment of a display on a remote control device for remotely control multiple displays for delivery of instructional information from multiple inputs in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module. Where a module or portions of a module are implemented in software, the software portions are stored on one or more computer readable media.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present invention provides to instructors and students a comprehensive tool for information delivery and education that conforms the classroom to the way learning is actually achieved. The development of the invention, which is called Super Teaching, is based on research results which indicate that for human beings, each a highly differential learner, tri-screen delivery of information works to elevate human concentration patterns by “leading” the mind, rather than having the mind on “pause” waiting for information to move forward. Super Teaching is described in detail by Dohrmann, U.S. Patent Application Publication No. 2002/0132216 A1, filed Oct. 18, 2001, which is hereby incorporated by reference. Technology assisted teaching produces superior results evidenced by improved test scores compared to those without technology assistance. The present system, apparatus, and method provide a saturation learning environment that stimulates both left and right sides of brain. In this type of learning, with more integrated involvement from instructor and multimedia system, higher level of retention is obtained compared to when instructor assistance or the automated system is missing from the classroom experience.

The present invention takes Super Teaching a step further in providing the instructor with a degree of freedom not available previously. The present invention provides a remote control device with presets. Each preset allows the instructor to connect multiple inputs to multiple display devices. Preferably, the presets are grouped and color coded to provide a user friendly remote control device that allows minimal effort by the instructor to achieve desired displays. In one embodiment, the remote control device includes a touch screen with icons. The icons are presets that may be color coded and may include text.

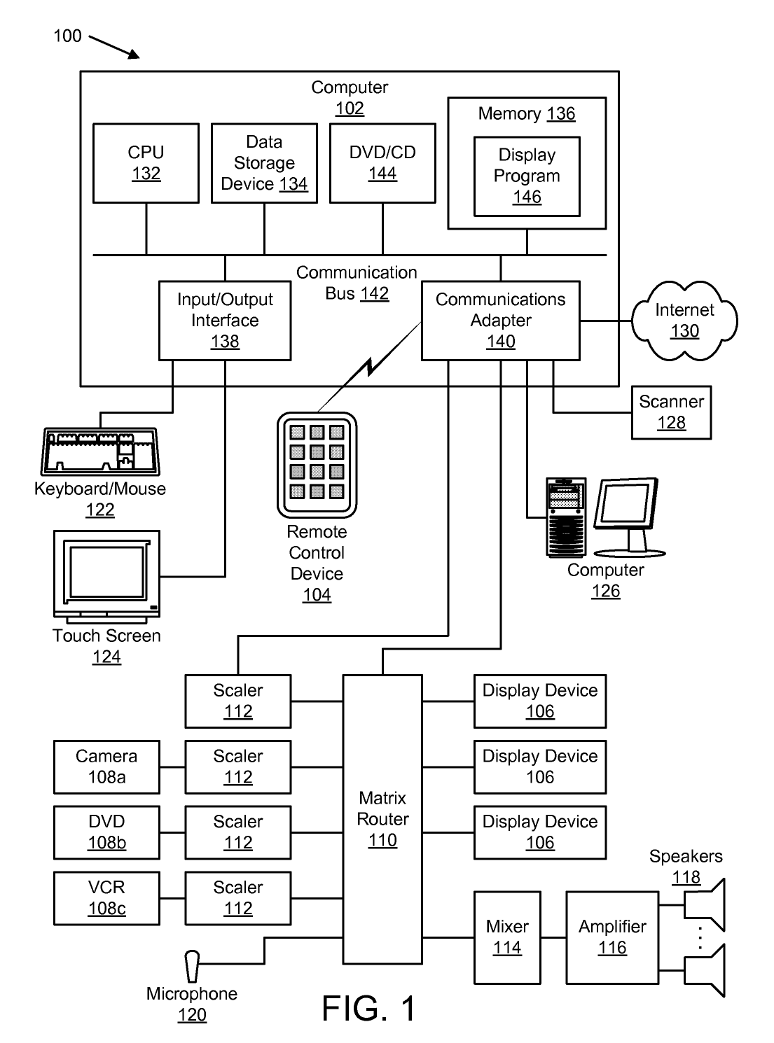

FIG. 1 depicts a schematic block diagram illustrating one embodiment of a system 100 to remotely control multiple displays for delivery of instructional information from multiple inputs in accordance with the present invention. The system 100 may be used in conjunction with Super Teaching. The system 100 includes a computer 102, a remote control device 104, display devices 106, and input devices 108, such as camera 108a, digital video disk (“DVD”) players 108b, and video cassette recorders (“VCR”) 108c. In one embodiment, the system 100 includes a matrix router 110, scalers 112, a mixer 114, an amplifier 116, speakers 118, and a microphone 120. The computer 102 may include a keyboard/mouse 122, and a display such as a touch screen 124.

The computer 102 may be connected to a second computer 126, image capture equipment such as a scanner 128, and to other computers, servers, etc. through the Internet 130. The computer 102 includes a central processing unit (“CPU”) 132, a data storage device 134, a memory 136, an input/output interface 138, and a communications adapter 140—all connected by a communication bus 142. In one embodiment, the computer 102 includes a DVD/compact disk (“CD”) player 144. The memory 136 of the computer 102 includes a display program 146. The above mentioned system components are described in detail below.

The system 100 includes a computer 102 that is in communication with the remote control device 104, at least three display devices 106, and the input devices 108. The computer 102, for example, may be a personal computer, a laptop computer, a workstation, a server, or the like. The computer 102 may be located in the same room as the display devices 106, the remote control device 104, and input devices 108, or may be located in a remote location. The computer 102 may be a single, stand alone computer or may be part of a network with multiple computers. The present invention may be located on one stand-alone computer 102 or may have functions and components distributed and controlled by multiple computers.

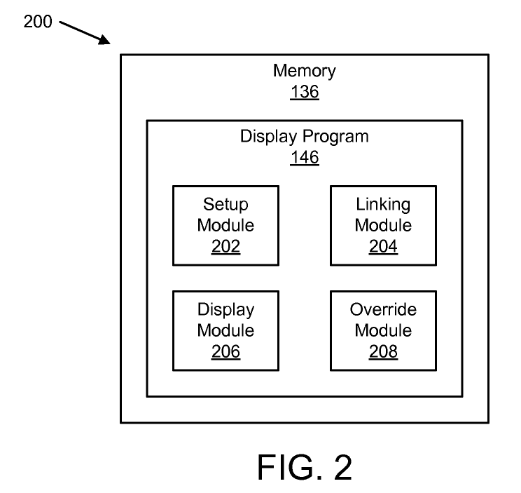

The computer 102 includes a CPU 132 to execute commands and control operations within the computer 102. The computer 102 may include one or more data storage devices 134. The data storage devices 134 typically include non-volatile memory and may include a hard disk drive, an optical drive, a flash memory, etc. The computer 102 includes memory 136 that typically stores data typically for quick retrieval. The memory 102 is typically non-volatile memory and may be in the form of random access memory (“RAM”). The memory 136, in one embodiment, includes a display program 146 that remotely controls multiple displays for delivery of instructional information from multiple inputs. The display program 146 may be stored in a data storage device 134 and copied to the memory 136 while an instructor is using the display program 146. The display program will be discussed in detail below in relation to the apparatus 200 of FIG. 2.

The computer 102 typically includes an input/output interface 138. The input/output interface 138 typically connects to input/output (“IO”) devices such as a keyboard and mouse 122, a display such as a touch screen 124, a stylus, etc. and allows users to control the computer 102 and view displays generated by the computer 102. The computer 102 also includes a communication adapter 140 for communication with other devices using a local area network (“LAN”), a wide area network (“WAN”), the Internet 130, a wireless network, etc. The communication adapter 140 allows communication with other computers 126, peripheral devices such as a scanner 128, and the remote control device 104. In another embodiment, the remote control device 104 communicates with the computer 102 over the input/output interface 138.

The computer 102 may also include a removable data storage device such as a DVD/CD player 144, a floppy disk drive, a tape drive, an optical drive, a ZIP drive, etc. The computer 102 may include a communication bus 142 to communicate with the various components within the computer 102. The communication bus 142 may include multiple buses and systems allowing communication between components. One of skill in the art will recognize other computer components, buses, devices, and configurations of a computer 102 used to remotely control multiple displays for delivery of instructional information from multiple inputs.

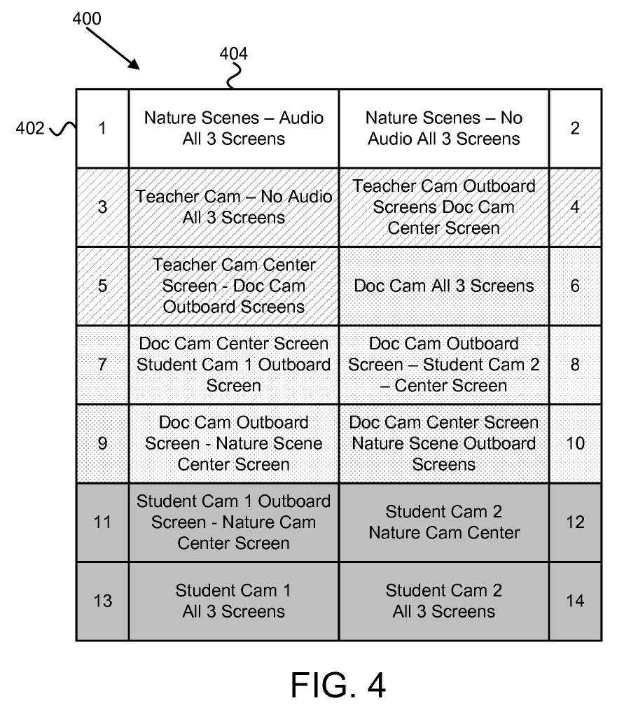

The system 100 includes a remote control device 104 that includes presets. Each preset is configured to execute a display instruction. Each display instruction is programmed to display images from the input devices 108 on the display devices 106. The remote control device 104, in one embodiment, includes preset buttons. In another preferred embodiment, the remote control device 104 includes a touch screen and the presets are icons displayed on the touch screen. The icons, in one embodiment, are color coded and each color represents a group. A group may include a common command, such as displaying a certain input device 108. The presets may also include text to identify the inputs to be displayed on the display devices 106. For example, the presets may identify a particular camera 108a as an input. The preset buttons or icons may include patterns, images, etc. to help identify groups or individual presets. The presets are discussed in more detail in relation to FIG. 4.

The remote control device 104, in one embodiment, includes override and other control functions in addition to presets. While a preset may connect particular input devices 108 to the display devices 106, an override function may allow control of a single display device 106. Control functions may control other devices, such as the computer 102. For example, a control function may cause the computer 102 to turn off or on. The override and control functions may be in the form of buttons or icons, or a combination of buttons and icons, on the remote control device 104.

The remote control device 104, in one embodiment, communicates with the computer 102 by way of infrared signals. An infrared receiver may be located on the computer 102 or positioned in a classroom or other location convenient to the display devices 106 and then connected to the computer 102. For example, if the computer 102 is in another room or in a cabinet, an infrared receiver may be wired to the computer 102 and then positioned at the front of a classroom.

In another embodiment, the remote control device 104 includes a wireless connection to the computer 102. For example, the wireless connection may be part of a wireless network connection, such as a connection complying with the IEEE 802.11 standard. In another embodiment, the wireless connection is a Bluetooth connection. Beneficially, a remote control device 104 with presets frees an instructor from standing at one location to lecture. With a remote control device 104, an instructor is free to roam about a classroom and can more easily see what is displayed by the display devices 106. Without the remote control device 104, typically an instructor would have to constantly turn his head to view a screen or similar display or would need to have the images of the display devices 106 duplicated on a monitor or touch screen 124 near the computer 102. One of skill in the art will recognize other remote control devices 104 with presets that connect input devices 108 to display devices 106.

The system 100 includes display devices 106 where each is capable of displaying a separate image, preferably to students in a classroom. Preferably, the system 100 includes three display devices 106, but may include as few as two devices and may include more than three devices. The display devices 106 may project an image to a screen or may display an image on the display device 106. For example, a display device 106 may be a projector, a monitor, a television, etc. The system 100 may include display devices 106 of the same type or may have different kinds of display devices 106. The display devices 106 are capable of receiving input from an input device 108, either directly or through a switching device such as the matrix router 110 where the input signal provided to the display device 106 is controlled by the computer 102.

In one embodiment, the computer 102 functions as an input device 108 as well as controlling input to the display devices 106. In one embodiment, the computer may send an image stored in a data storage device 134 or memory 136. In other embodiments, the computer 102 sends an image to a display device 106 received from a scanner 128, another computer 126 in communication with the computer 102 over a LAN, WAN, wireless LAN, or the Internet 130. In one embodiment, the computer 102 provides input to one display device 106. In another embodiment, the computer 102 provides input to multiple display devices 106. The computer 102 may also receive input signals from cameras 108a, DVD players 108b, VCRs 108c, etc. One of skill in the art will recognize other ways that a computer 102 can provide input to one or more display devices 106 as well as controlling the display devices 106.

In one embodiment, a display device 106 processes audio signals that may be input from either the input device 108 providing an image to the display device 106 or from another source. The display device 106 may include internal speakers or may provide connectors for speakers 118, a mixer 114, or an amplifier 116. In one embodiment the display device 106 includes an amplifier 116 and/or mixer 114.

A display device 106, in one embodiment is capable of receiving a signal from the computer 102 or matrix router 110 without signal conditioning. In another embodiment, a display device 106 includes other devices for signal processing to convert an input signal to a signal type compatible with the display device 106. One of skill in the art will recognize other forms and types of display devices 106 capable of displaying an input signal from an input device 108, 102 in response to a command from a computer 102, either directly or through a device such as a matrix router 110.

The system 100 includes, in one embodiment, display devices 106 separate from the computer 102. For example, one or more cameras 108a may serve as input devices 108. Preferably, the system 100 includes at least one document camera 108a capable of displaying a document placed in front of the camera 108a, as well as one or more student cameras 108a pointed at students in a classroom or people in a room. The cameras 108a may be fixed or may have a pan/tilt/zoom feature and may produce a digital or an analog signal. A camera 108a providing an analog signal may require an analog to digital converter in order to provide a signal suitable for input into a matrix router 110, a computer 102, or display device 106. In one embodiment, a camera 108a includes a microphone and provides an audio signal.

The system 100, in another embodiment, includes one or more DVD players 108b. VCRs 108c, tape players, digital audio tape (“DAT”), TV tuners, MP3 players, etc. configured as input devices 108. The input devices 108 may be located with the computer 102, in a rack, in a cabinet, etc. The input devices 108 may have capacity for only one DVD, CD, video cassette tape, DAT or may have a rack or platter to select from more than one media type. The input devices 108 may provide an image signal only or may provide image and sound signals. The input devices 108 may have multiple outputs and may play multiple media types simultaneously. One of skill in the art will recognize other input devices 108 that may provide an image to a display device 106 and possibly an audio signal output.

In one embodiment, the system 100 includes a matrix router 110 that connects input devices 108 to display devices 106 as commanded by the computer 102. The matrix router 110 typically includes input connections output connections for multiple devices. In one embodiment, the matrix router 110 receives and outputs RGB video display signals through BNC connectors. In other embodiments, the matrix router 110 inputs and outputs composite video, S-Video, DVI, VGA, etc. signals through RCA, coaxial, or other connector types.

The matrix router 110, in one embodiment, includes audio inputs and outputs. In one embodiment, the audio outputs are paired with video signals. In another embodiment, audio signals may be switched separately from the video signals. For example video signal 1 may be connected to video output 1 while audio signal 1 may be connected to audio output 3. The matrix router 110 is controlled by the computer 102. The computer 102 typically sends display commands that connect an input of the matrix router 110 to an output, enable inputs and outputs, etc. The matrix router 110 may communicate with the computer 102 by way of an RS-232 signal, an RS-485 signal, or the like.

In one embodiment, the matrix router 110 is a single device, such as the Kramer VP-1608 matrix router. In another embodiment, the matrix router 110 includes multiple devices, such as switchers that receive multiple inputs and have only one output. In yet another embodiment, the functions of the matrix router 110 are included in the computer 102 configured to receive multiple inputs and with one or more video cards capable of driving several display devices 106. One of skill in the art will recognize other devices and configurations that function as a matrix router 110 capable of connecting one or more input devices 108 to multiple display devices 106.

In one embodiment, the system 100 includes scalers 112 that condition the output signals from the input devices to a signal type compatible with a matrix router 110, computer 102, or display device 106. For example, the scalers 112 may be Kramer VP-413 scalers, or equivalent. Typically, a scaler 112 is capable of receiving a variety of signal types and converting the signals to RGB video signals. For example, a scaler 112 may receive composite video signals, S-Video signals, etc.

In one embodiment, the system 100 includes an audio system that may include a mixer 114, an amplifier 116, and speakers 118. The mixer 114, in one embodiment, is not included. The mixer 114, where included may provide a capability to adjust sound levels for optimum listening. An amplifier 116 is typically included to drive the speakers 118. The speakers may be located at the front of a classroom or other room or may be distributed throughout the classroom. The audio system 114, 116, 118 may receive an audio signal from a matrix router 110, the computer 102, from an input device 108, or from a display device 106. In one embodiment, an input device 108 or display device 106 includes an amplifier 116 and/or mixer 114. In another embodiment the speakers 118 are self-powered speakers.

The system 100, in one embodiment, includes one or more microphones 120 configured to provide an audio input to the matrix router 110, computer 102, or display device 106. For example, the microphone 120 may be used by an instructor, by students, or other individuals in a classroom or other room. In one embodiment, the microphone 120 is connected by a wire. In another embodiment, the microphone 120 is a wireless microphone.

In one embodiment, the system 100 includes a touch screen 124 or other display configured as a graphical user interface (“GUI”). In one embodiment, the touch screen 124 includes preset icons that match the presets of the remote control device 104. In another embodiment, the touch screen/display 124 displays one or more images that are displayed by the display devices 106. For example, the matrix router 110 or computer 102 may display the images on the display devices 106 simultaneously with a split screen image on the touch screen/display 124. In a preferred embodiment, the remote control device 104 includes all of the functionality of the touch screen 124. In another embodiment, the touch screen 124 includes full control of the system 100, while the remote control device 104 includes a reduced control set or just presets. In another embodiment, the presets displayed on the touch screen 124 are different (more or less detailed) than the presets of the remote control device 104. In yet another embodiment, the system 100 includes multiple touch screens/displays 124. One of skill in the art will recognize other configurations of one or more touch screens/displays 124 capable of controlling the computer 102 and displaying images.

In one embodiment, the computer 102 provides input to one or more display devices 106. For example, the computer 102 may provide images from a data storage device 134, such as a hard drive of the computer 102, to one or more display devices 106. In another example, a DVD/CD player 144 of the computer 102 provides one or more images to a display device 106. The computer 102, in other example, receives one or more images to the display devices 106 from an external device, such as another computer 126 over a LAN, Internet connection, etc., a scanner 128, a zip drive, a flash drive, etc. One of skill in the art will recognize other ways that the computer 102 may provide input to one or more display devices 106.

FIG. 2 is a schematic block diagram illustrating one embodiment of an apparatus 200 to remotely control multiple displays for delivery of instructional information from multiple inputs in accordance with the present invention. The apparatus 200 includes the display program 146 located, in one embodiment, in the memory 136 of the computer 102. The display program 146 may also be located in a data storage device 134 or other storage device.

The display program 146 includes a setup module 202 that stores display instructions. Each display instruction displays at least one image of an input device 108, 102 on each display device 106. In one embodiment, the display instructions are commands to the matrix router 110 to connect an input device 108, 102 to an output device 106. In another embodiment, the display instructions are commands to routers where each router is connected to a single display device 106. In yet another embodiment, the display instructions connect input devices 108, 102 connected to the computer 102 to display devices 106 connected to the computer 102. The display instructions may also include instructions to turn on or off a display device 106, the matrix router 110, scalers 112, input devices 108, or otherwise control the devices 106, 108, 110, 112. Typically, the display instructions are routed from the computer 102 to the devices 106, 108, 110, 112. One of skill in the art will recognize other computer commands, computer code, display instructions, etc. that together form a display instruction to connect an input device 108, 102 to a display device 106.

The setup module 202 in one embodiment, stores display instructions in a table where each row of the table corresponds to a display instruction and each column corresponds to a display device 106. A table may be a convenient user interface for programming display instructions. The table may then be translated to instructions compatible with the computer 102, matrix router 110, display devices 106, etc. An input device 108 may be assigned to a particular display device 106 of a display instruction by placing an input device 108 name in the cell of the table corresponding to the particular display instruction row and display device 106 column. If a camera 108a is to be connected to a first display device 106 for a first display instruction, the cell corresponding to the first column and first row may be filled in with some name, identifier, command, etc. that refers to the camera 108a. The position in the table ties the camera 108a to a specific display instruction and display device 106.

In another embodiment, a display instruction includes computer code in a high level programming language. In yet another embodiment, a display instruction may be in a low level language, such as an assembly language. The setup module 202 may include a graphical display that allows a user to graphically assemble display instructions. One of skill in the art will recognize other ways that the setup module 202 may store display instructions.

Typically, a display instruction is a group of commands or display instructions and connects one or more inputs to the display devices 106 such that each display device 106 has an input for display. In one embodiment, a display instruction changes the display on one display device 106 while maintaining the display on the other display devices 106. In another embodiment, a display instruction changes the display on more than one display device 106 while maintaining the display on one display device 106. In yet another embodiment, a display instruction changes the display on all of the display devices 106. One of skill in the art will recognize other display instructions to start or change the display on one or more display devices 106.

The display program 146 includes a linking module 204 that links a display instruction with a preset icon. The preset icon is located on the remote control device 104. The linking module 204 links the display instruction such that selecting the preset causes the linked display instruction to execute and display images on the display devices 106.

The display program 146 includes a display module 206 that displays the images from the input devices 108, 102 on the display devices 106 associated with a display instruction in response to a user selecting the preset linked to the display instruction. In one embodiment, the preset is a button on the remote control device 104. In another embodiment, the remote control device 104 includes a touch screen and the preset is an icon that executes the display instruction when selected. For example, a user may press a preset button or icon to select the preset.

In a preferred embodiment, the display module 206 displays instructional information on at least one display device 106 and then displays background information on the other display devices 106. For example, the display module 206 may display information related to a lesson being taught by the instructor on one display device 106. The instructional information may be stored in the computer 102. For example, the instructional information may include a sequence of slides that include text, illustrations, etc. In one example, the instructional information is in the form of a PowerPoint® presentation. In another example, the instructional information may be presented by connecting to a document camera 108a focused on an area designed for an instructor to place documents. A document placed below the camera 108a is then captured and transmitted to the display 106 of instructional information using the display module 206. In another embodiment, the instructional information is in the form of an instructor presenting information. For example, a camera 108a may focus on the instructor while the instructor is speaking and teaching. The image of the instructor is captured by the camera 108a and displayed by the display device 106 using the display module 206.

In the preferred embodiment, while the display module 206 displays instructional information on one or more display devices 106, the display module 206 displays background information on two or more remaining display devices 106. For example, the display module 206 may display random pictures, such as nature scenes, student pictures, lesson material, or the like. An important aspect of Super Teaching is that the mind is easily distracted so typical teaching methods are inadequate because the students lose interest and divert their attention from what is being presented by the instructor. By presenting randomly sequenced background information on the display devices 106 not displaying instructional information, the student's minds are refocused on the displays and learn more than if only a single display is provided with the instructional information.

In one embodiment, the background information is controlled by table-driven timeouts. For example, if the instructor selects Preset 1 on the remote control device corresponding to a document camera 108a, the display module 206 displays on one display device 106 images captured by the document camera 108a and also displays background information on the remaining display devices 106. For the background displays, a table may dictate timing of each image displayed. The table may also indicate content of the background images and possibly the source of the images. For example, the table may be populated using the setup module 202 and may include display instructions that select a particular source 108, 102 and the timing of each image to be displayed. In one embodiment, timing of each image is random.

In the embodiment, the linking module 204 may link Preset 1 with a row of the table. The row corresponding to Preset 1 (e.g. Row 1), for example, may have display commands in the first column of Row 1 may select the document camera 108a for a center display device 106. A second column of Row 1 may select the DVD 108b as an input, direct the DVD signal to a left display device 106 and may use a random sequence to display images from the DVD 108b. A third column of Row 1 may select images stored in the data storage device 134, direct the images to a right display device 106 and may again use a random sequence to display images from the data storage device 134. In other embodiments, the display module 206 uses sequenced commands, algorithms, subroutines, etc. to display instructional information on one display device 106 and background images on the other display devices 106 and to control timing of the display of the images. One of skill in the art will recognize other ways to display instructional information on at least one display 106 while displaying background information on the remaining displays 106.

The preset may include text on or near the preset to identify the preset's function. In another embodiment, the preset includes a symbol to identify the preset's function. For example, if the system 100 includes three display devices 106, the preset may include three boxes side-by-side and a box is darkened to indicate which display is affected by the preset. In another example, the presets include boxes with corresponding numbers where the numbers correspond to input devices 108. The presets may also be color coded to identify the presets with a group. For example, one color may represent a particular input device 108, such as a camera 108a. One of skill in the art will recognize other ways to identify a preset function or display instruction linked by the linking module 204 to the preset of a remote control device 104.

In one embodiment, the display program 146 includes an override module 208 that displays at least one override function of the remote control device such that selecting an override function overrides at least a portion of a display instruction being executed. For example, an override function may be a button or icon. For example, a user may select a preset that includes displaying an image from a camera 108a on a display device 106. An override function on the remote control device 104 may allow a user to switch the input device 108 connected to the display device 106 from the camera 108a to a DVD player 108b, a VCR 108c, an image from another computer 126, etc. The remote control device 104 may include any number of override functions in the form of buttons or icons that allow a user to control individual display devices 106. The remote control device 104 also includes the presets as described above.

For example, if Preset 1 is selected and instructional material is displayed on a center display device 106 while background information is displayed on the left and right displays 106, an override button or preset on the remote control device 104 may select instructional material, such as a PowerPoint presentation, for the right display device 106. One of skill in the art will recognize other override functions, presets, and other controls on a remote control device 104 to allow a user to connect input devices 108 to display devices 106 through the computer 102.

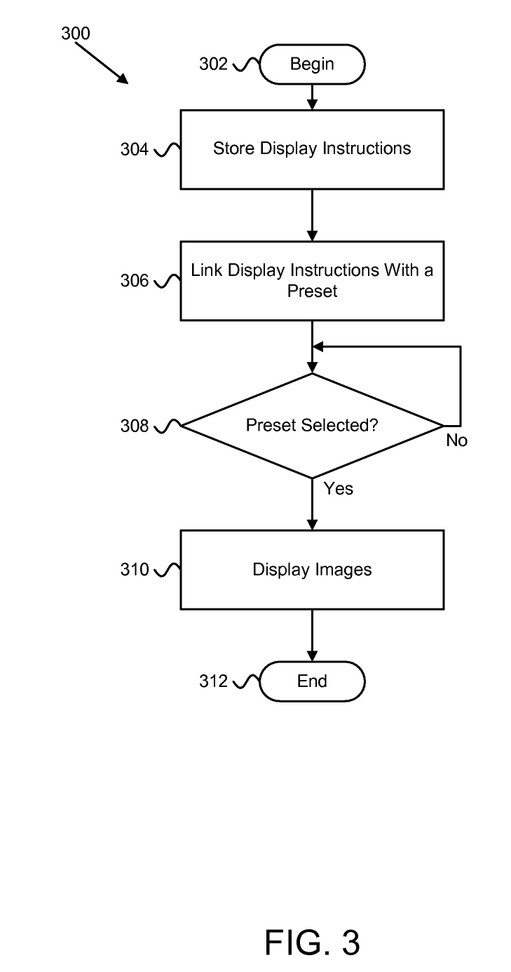

FIG. 3 is a schematic flow chart diagram illustrating one embodiment of a method 300 for remotely controlling multiple displays for delivery of instructional information from multiple inputs in accordance with the present invention. The method 300 begins 302 and the setup module 202 stores 304 a plurality of display instructions. Each display instruction displays at least one image of an input device 108 on each display device 106. The setup module 202 may include a graphical interface, table, etc. that allows a user to generate display instructions.

The linking module 204 links 306 a display instruction with a preset where the preset is located on the remote control device. The linking module 204 may include a user interface to allow a user to link a display instruction with a display instruction. The linking module 204 may link a display instruction to an icon on a touch screen of the remote control device 104.

The display module 206 determines 308 if a preset is selected. If the display module 206 determines 308 that a preset has not been selected, the display module 206 continues to monitor commands from the remote control device 104. If the display module 206 determines 308 that a preset is selected, the display module 206 displays 310 the images from the input devices 108 on the display devices 106 associated with a display instruction and the method 300 ends 312.

FIG. 4 is a schematic block diagram illustrating one embodiment of a display 400 on a remote control device 104 for remotely control multiple displays for delivery of instructional information from multiple inputs in accordance with the present invention. The display 400 is an example of a possible touch screen display for a remote control device 104. The display 400 includes icons with one portion including a number 402 and one portion including a descriptive label 404.

The icons may also be color coded or may include a pattern (as shown) corresponding to groups. For example, a group may include display instructions that connect an input device 108 that provides images of nature scenes. The nature scene group is depicted on the display 400 as icons with a white background. The display 400 includes icons 1 and 2 in the nature scene group. Icon 1 402, 404, here labeled “Nature Scenes—Audio, All 3 Screens” may be linked to a display instruction that connects one or more input devices 108 with nature scenes to three display devices 106 and may connect an audio signal from an input device 108 such that sound is broadcast through the speakers 118.

The display 400 includes icons 3, 4, and 5 in a “Teacher Cam” group. Icons 6-10 are included in a document cam group and icons 11-14 are included in a student cam group. One of skill in the art will recognize other ways to group icons or presets and to label or identify icons or presets on a remote control device 104 where the presets/icons display images from input devices 108 on display devices 106 when selected.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to remotely control multiple displays for delivery of instructional information from multiple inputs, the apparatus comprising:
a setup module configured to store a plurality of display instructions, each display instruction configured to display at least one image of one or more input devices on each of at least three display devices, each display device capable of displaying a separate image to students in a classroom;
a linking module configured to link one or more display instructions with a preset, the preset located on a remote control device, the remote control device comprising a plurality of presets; and
a display module configured to display the images from the input devices on the display devices associated with a display instruction in response to a user selecting the preset linked to the one or more display instructions.

2. The apparatus of claim 1, further comprising an override module configured to display at least one override function of the remote control device such that selecting the at least one override function overrides at least a portion of a display instruction being executed.

3. The apparatus of claim 1, wherein the display module displays instructional information one at least one display device and background information on the display devices not displaying instructional information.

4. The apparatus of claim 3, wherein the background information comprises images displayed in a random sequence.

5. A system to remotely control multiple displays for delivery of instructional information from multiple inputs, the system comprising:
at least three display devices each capable of displaying a separate image to students in a classroom;
at least one input device configured to output at least one image;
a remote control device comprising a plurality of presets;
a microprocessor in communication with the at least three display devices, the at least one input device, and the remote control device, the microprocessor comprising
a setup module configured to store a plurality of display instructions, each display instruction configured to display at least one image of an input device on each display device;
a linking module configured to link one or more display instructions with a preset, the preset located on the remote control device; and
a display module configured to display the images from the input devices on the display devices associated with a display instruction in response to a user selecting the preset linked to the one or more display instructions.

6. The system of claim 5, wherein the remote control device further comprises a touch screen and the presets comprise icons on the touch screen.

7. The system of claim 5, further comprising a router configured to connect the input devices to the display devices in response to a display instruction received by the router from the computer.

8. The system of claim 7, further comprising an audio system configured to receive sound of an input device through the router, the audio system comprising an amplifier and at least one speaker.

9. The system of claim 5, wherein the one or more display instructions comprise an instruction for each display device and each of the instructions comprises connecting one input device to one display device.

10. The system of claim 5, wherein the at least one input device is one of a camera, a digital video disk (“DVD”) player, a video cassette recorder (“VCR”), an Internet web page, a compact disk (“CD”) player, a scanner, a digital audio tape player, a flash memory drive, an optical drive, a hard disk drive, and the computer.

11. The system of claim 5, further comprising an override module configured to display at least one override function of the remote control device such that selecting the at least one override function overrides at least a portion of a display instruction being executed.

12. The system of claim 5, wherein the at least three display devices comprise three projectors that display images on three projection screens.

13. The system of claim 12, wherein the projection screens are configured in a “V” configuration.

14. The system of claim 5, wherein at least one preset is configured to display a mix of background images and lesson text.

15. The system of claim 5, wherein the setup module stores the plurality of display instructions in a display table.

16. The system of claim 5, wherein the remote control device comprises presets that are included on a non-remote touch screen device.

17. A computer program product comprising a computer readable medium having computer usable program code executable to perform operations for remotely controlling multiple displays for delivery of instructional information from multiple inputs, the operations of the computer program product comprising:
storing a plurality of display instructions, each display instruction configured to display at least one image of one or more input devices on each of at least three display devices, each display device capable of displaying a separate image to students in a classroom;
linking one or more display instructions with a preset, the preset located on a remote control device, the remote control device comprising a plurality of presets; and
displaying the images from the input devices on the display devices associated with a display instruction in response to a user selecting the preset linked to the one or more display instructions.

18. The computer program product of claim 17, wherein further comprising displaying at least one override function of the remote control device such that selecting the at least one override function overrides at least a portion of a display instruction being executed.

19. The computer program product of claim 17, wherein displaying the images further comprises displaying instructional material on at least one display device and displaying background information on the display devices not displaying instructional information.

20. The computer program product of claim 19, wherein displaying background information further comprises displaying images in a random sequence.
